(19) United States
(12) Patent Application Publication
(10) Pub. No.: US 2017/0052612 A1
(43) Pub. Date: Feb. 23, 2017

(54) DISPLAY OPERATING SYSTEM

(71) Applicant: DENSO CORPORATION, Kariya-city, Aichi-pref. (JP)

(72) Inventor: Shigeaki NISHIHASHI, Kariya-city (JP)

(21) Appl. No.: 15/307,460

(22) PCT Filed: Apr. 8, 2015
(86) PCT No.: PCT/JP2015/001978

§ 371 Date: Oct. 28, 2016

(30) Foreign Application Priority Data
May 9, 2014 (JP) 2014-097876

(51) Int. Cl. G06F 3/0354; G06F 3/0362

(52) U.S. Cl. CPC G06F 3/03547; G06F 3/0362

(57) ABSTRACT

A display operating system including a contact detector, a displacement detector, a region selector and a position specifier is provided. The contact detector detects a contact position where a user contacts an operation surface. The displacement detector includes a connection member connected to the contact detector and two dimensionally movable and detects a two dimensional coordinate point indicating displacement of the connection member. Using one of a contact detection result of the contact detector and a displacement detection result of the displacement detector, the region selector selects one of display regions configured on a display screen of a display device displaying an image. Using the other of the contact detection result and the displacement detection result, the position specifier specifies a position in the display region selected by the region selector.

### CROSS REFERENCE TO RELATED APPLICATION

This application is based on Japanese Patent Application No. 2014-97876 filed on May 9, 2014, disclosure of which is incorporated herein by reference.

### TECHNICAL FIELD

The present disclosure relates to a display operating system for selecting an image in a display screen in response to a user's operation.

### BACKGROUND ART

There is known a system that has a region selection mode for selecting any intended one of multiple display regions in a display screen and a function selection mode for selecting an icon inside the selected display region, and that enables a touch pad operation to make the selection in the function selection mode (for example, see Patent Literature 1).

Patent Literature 1: JP 2013-134509A

### SUMMARY OF INVENTION

According to studies by the inventor of the present application, because the selection of the display region and the selection of an icon in the display region are made on the same operation surface of the touch pad in the technology of Patent Literature 1, the selection operation may be wrongly made.

In view of the foregoing problem, it is an object of the present disclosure to suppress an occurrence of a wrong operation in selection a display region and selection inside the display region.

A display operating system in an example of the present disclosure comprises a contact detector, a displacement detector, a region selector and a position specifier.

The contact detector has an operation surface and detects a contact position where a user contacts the operation surface. The displacement detector includes a connection member connected to the contact detector and movable in two dimensional directions and detects a two dimensional coordinate point indicating displacement of the connection member.

Using one of a contact detection result of the contact detector and a displacement detection result of the displacement detector, the region selector selects one of a plurality of display regions configured on a display screen of a display device, wherein the display device displays an image. Using the other of the contact detection result and the displacement detection result not used by the region selector, the position specifier specifies a position in the display region selected by the region selector.

In the above display operating system, the contact detector first detects the contact position on the operation surface, that is, a two dimensional coordinate point on the operation surface. The display operating system of the present disclosure detects a two dimensional coordinate point indicating displacement of the connection member. Therefore, the user operating the display operating system can point to a first two dimensional coordinate point by contacting the operation surface of the contact detector and further can point to a second two dimensional coordinate point by moving the connection member of the displacement detector.

Because the position in the display screen of the display device can be pointed to with the two dimensional coordinate point, the plurality of display regions configured on the display screen and the position in the display region can be pointed to with the first two dimensional coordinate point and the second two dimensional coordinate point.

Therefore, in the above display operating system, the selection of a display region in the display screen and the selection of a position in the display region, respectively and separately, can be made by instructions made by contacting with the operation surface and instructions made by moving the connection member. Accordingly, it becomes unnecessary to make, by instructions by made by contacting with the operation surface, both of the selection of a display region and the selection of a position in the display region, and hence an occurrence of a wrong operation is suppressed.

### BRIEF DESCRIPTION OF DRAWINGS

The above and other objects, features and advantages of the present disclosure will become more apparent from the below detailed description made with reference to the accompanying drawings. In the drawings:

FIG. 1 is block diagram illustrating a schematic configuration of a remote control system;

FIG. 2 is a perspective view illustrating a configuration of a movable part;

FIG. 3 is a perspective view illustrating a movable part in a held state;

FIG. 4 is a diagram illustrating a display screen of a display device and a movable part;

FIG. 5 is a flowchart illustrating an operation input process;

FIG. 6 is a plan view illustrating a movable part of another embodiment; and

FIG. 7 is a plan view illustrating a movable part of another embodiment.

### EMBODIMENTS FOR CARRYING OUT INVENTION

Embodiments will be described with the drawings.

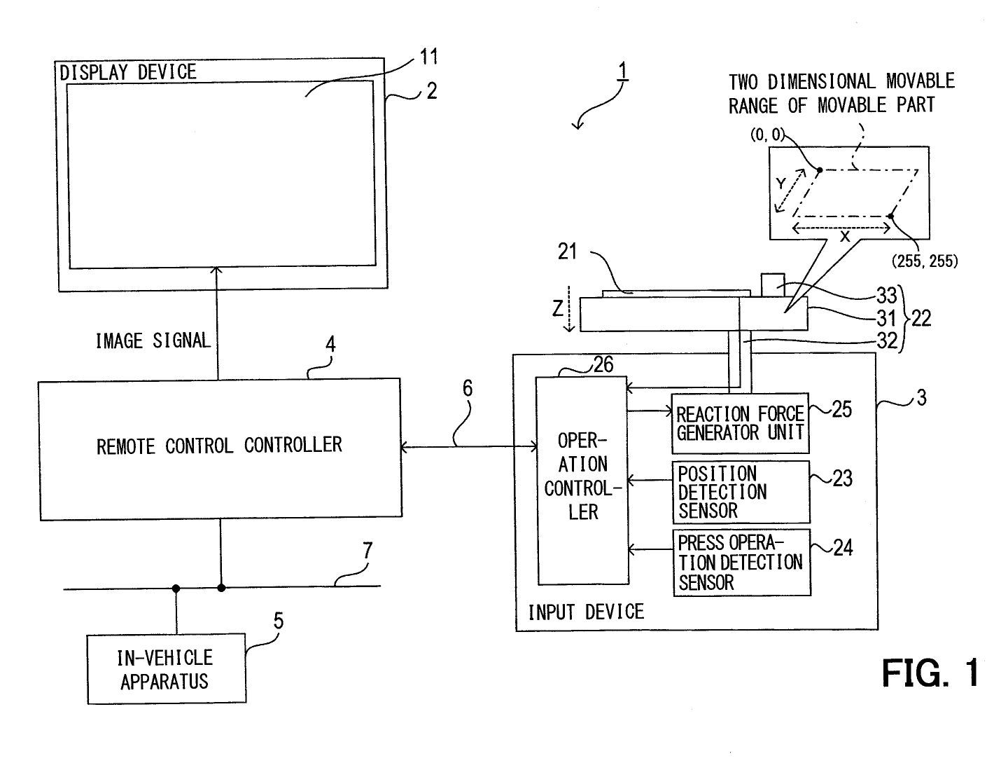

A remote control system 1 of the present embodiment is mounted in a vehicle and includes an input device 3, a remote control controller 4, and an in-vehicle apparatus 5 (for example, a navigation apparatus, an audio apparatus, an air conditioner etc.), as shown in FIG. 1.

The display device 2 is a color display device such as a liquid crystal display including a display screen 11, and displays various images on the display screen 11 according to image signals from the remote control controller 4.

The display device 2 is arranged on a dashboard (not shown) in front of a driver and positioned at a midway between a driver seat and a front passenger seat, so as to reduce a visual line movement of the driver when the driver looks at the display screen 11 of the display device 12. The input device 3 is arranged on a center console just next to the driver seat, so as to be easily operated by the driver without the driver's arm stretching and without driver's posture changing.

The input device 3 is a pointing device for inputting a cursor movement direction in the display screen 11 and an enter instruction. The input device 3 includes a touchpad 21, a movable part 22, a position detection sensor 23, a pressing operation detection sensor 24, a reaction force generator 25 and an operation controller 26.

The touchpad 21 includes an operation surface for contacting a user's fingertip. The touchpad 21 detects a fingertip contact position in the operation surface and outputs contact position information indicating this contact position.

The movable part 22 includes a mount portion 31, an axis portion 32, and a holding portion 33.

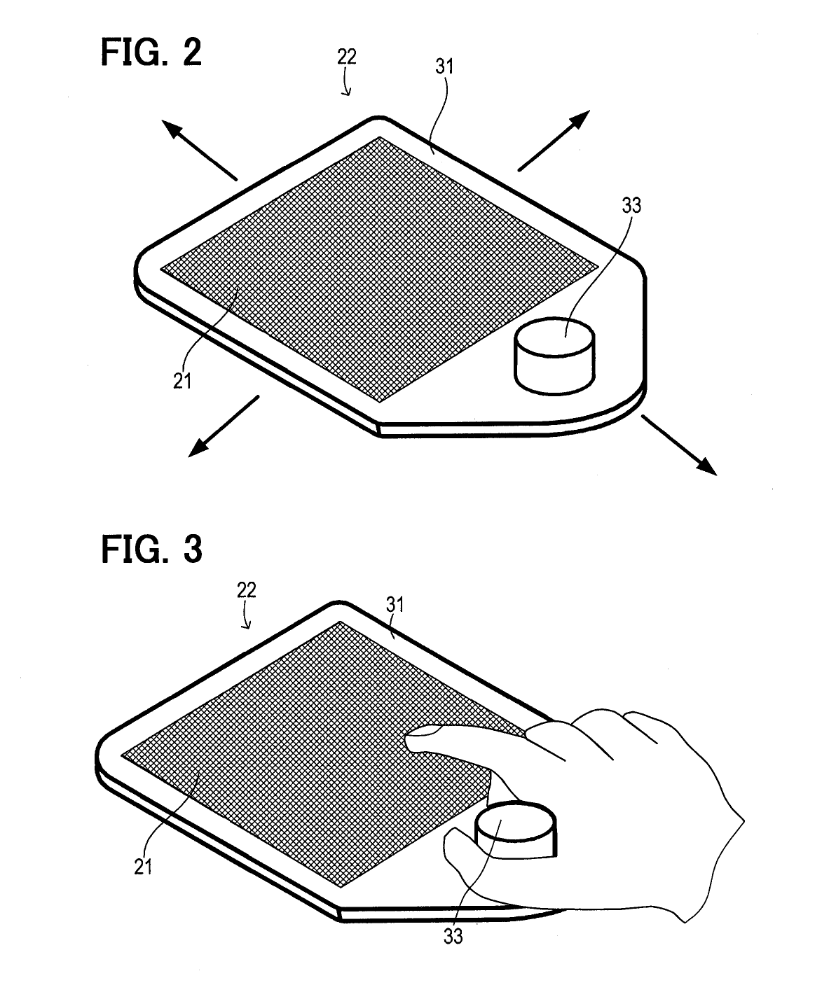

As shown in FIG. 2, the mount portion 31 is formed into a flat plate shape, and has a surface on which the touchpad 21 is mounted.

As shown in FIG. 1, the axis portion 32 has an upper end portion which is connected to a rear surface of the mount portion 31. The axis portion 32, with a lower end thereof acting as a fulcrum, is movable in two dimensional directions (directions donated by X, Y in the drawing) along a plane surface perpendicular to an axis direction of the axis portion 32.

Coordinates of the axis portion 32 in the X direction and the Y direction, respectively, have an integer from 0 to 255 and an integer from 0 to 255. The axis portion 32 returns to a center home position (neutral position) when a force in the two dimensional directions is not applied from the driver.

The axis portion 32 is also movable lower in its axis direction (a direction of the Z arrow in FIG. 1). When a force in a lower direction is not applied from the driver, that is, when the axis portion is not pressed down, the axis portion returns to an upper home position in the axis direction.

The holding portion 33 is to be held by the driver. As shown in FIG. 2, for example, the holding portion 33 is formed into a cylindrical shape and protrudes from the surface of the mount portion 31 so that an axis of the cylindrical shape is perpendicular to the surface of the mount portion 31. The holding portion 31 is arranged next to the touch pad 21 on the surface of the mount portion 31.

As shown in FIG. 3, when the driver holds the holding portion 33 with the holding portion 33 being held between a thumb and a forefinger, the driver can perform a touch operation with the forefinger and move the movable part 2 in the two dimensional directions.

As shown in FIG. 1, the position detection sensor 23 detects a coordinate point of the axis portion 32 in the X direction and the Y direction and outputs the operation position information indicating the coordinate point.

The pressing operation detection sensor 24 detects the pressing down of the axis portion 32 in the Z axis direction and outputs press operation detection information indicating this detection result.

The reaction force generation unit 25 supports the axis portion 32 and applies a reaction force to the axis portion 32 based on the coordinate point of the axis portion 32 in the X axis direction and the Y axis direction.

To the remote control controller 4, the operation controller 26 outputs the contact position information given from the touchpad 21, the operation position information given from the position detection sensor 23 and the press operation detection information given from the press operation detection sensor 24. When the axis portion 32 is displaced from the neutral position, the operation controller 26 causes, based on the operation position information, the reaction force generation unit 25 to generate the reaction force for returning the axis portion back to the neutral position.

The remote control controller 4 mainly includes a microcomputer with a CPU, a ROM, a RAM. an I/O and a bus line connecting these components, and executes various processes for the driver to perform remote control.

The remote control controller 4 and the input device 3 are communicably connected to each other via a dedicated communication line 6. The remote control controller 4 and the in-vehicle apparatus 5 are communicably connected to each other via an in-vehicle LAN (Local Area Network).

The remote control controller 4 causes the display device 2 to display an operation image for operations of the in-vehicle apparatus 5. The remote control controller 4 enables the driver to select various icons on this operation screen via the input device 3, and accepts inputs of instructions to execute the selected icon, thereby causing the in-vehicle apparatus to execute a function assigned to the instructed icon.

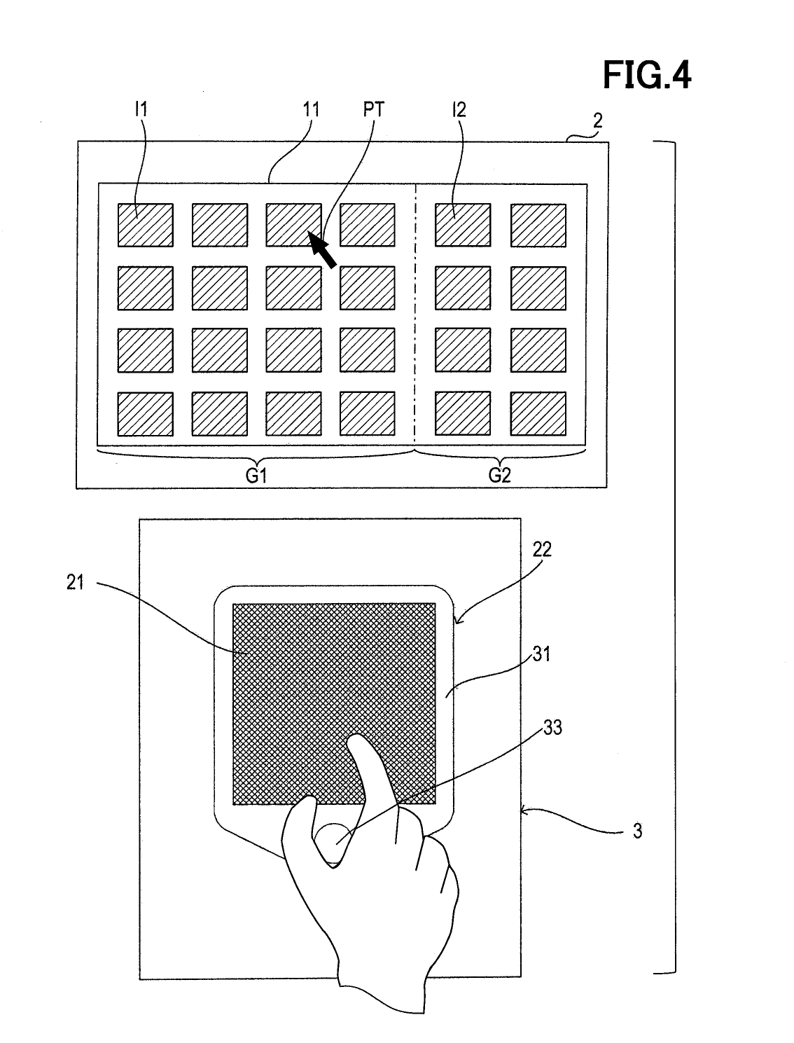

As shown in FIG. 4 for example, the remote control controller 4 displays two operation images G1 and G2 having different functions on the display screen 11 of the display device 2.

The operation image G1 is arranged on a left portion of the display screen 11 and the operation image G2 is arranged on the right portion of the display screen 11. The operation image G1 contains multiple icons I1 which are selectable and the operation image G2 contains multiple icons I2 which are selectable.

The operation image G1 is, for example, an image for inputting text characters indicating a destination when a search for the destination is made in the navigation apparatus. The icons I1 indicate selectable Japanese Katana alphabets. The operation image G1 indicates candidates of text strings containing the Japanese Katana alphabet selected in the operation image G1.

The driver can use the input device 3 to select one of the operation images G1 and the operation images G2 and select an icon contained in the selected operation image.

In the remote control system 1 configured above, the remote control controller 4 executes an input operation process.

Now, the input operation process executed by the remote control controller 4 will be described. This input operation process is executed while the remote control controller 4 is in operation.

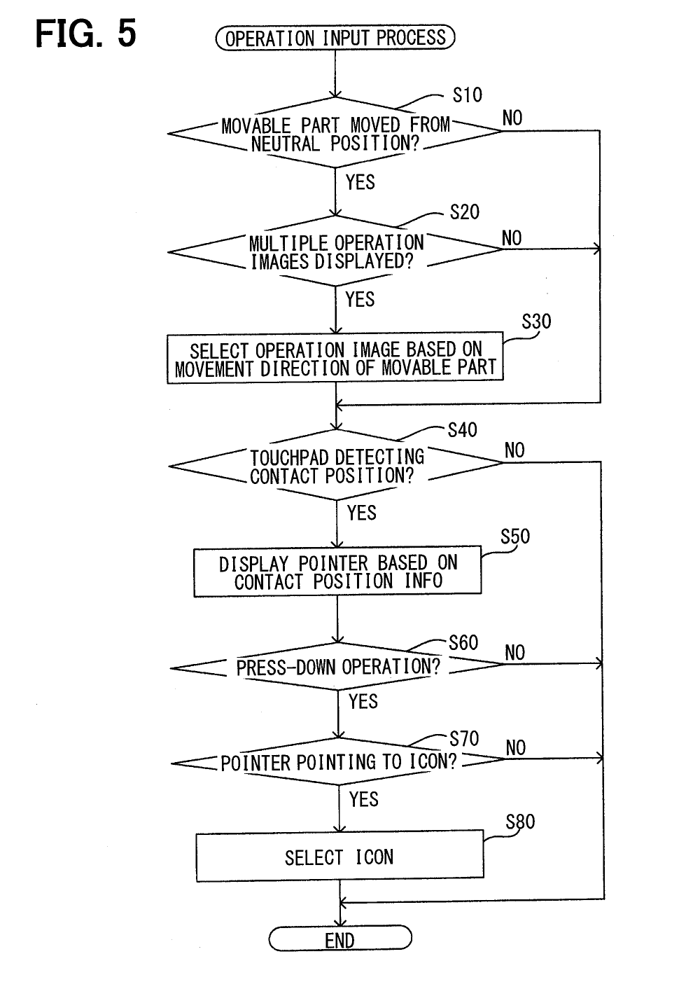

As shown in FIG. 5, upon start of the input operation process, first, the remote control controller 4 determines at S10 whether or not the movable part 22 is displaced from the neutral position, based on the operation position information from the position detection sensor 23. When the movable part 22 is not displaced from the neutral position (S10: NO), the process proceeds to S40. When the movable part 22 is displaced from the neutral position (S10: YES), it is determined at S20 whether or not multiple operation images are displayed on the display screen 11 of the display device 2.

When the number of operation images displayed on the display screen 11 is one (S20: NO), the process proceeds to S40. When the number of operation images displayed on the display screen 11 is two or more (S20: YES), the process proceeds to S30 in which the operation image is selected based on a movement direction of the movable part 22 relative to the neutral position and the process proceeds to S40. As shown in FIG. 4 for example, it is assumed that the operation image G1 is displayed on the left portion of the display screen 11 and the operation image G2 is displayed on the right portion of the display screen 11. In this case, when the movement direction of the movable part 22 is a left direction relative to the neutral position, the operation image G1 is selected. When the movement direction of the movable part 22 is a right direction relative to the neutral position, the operation image G2 is selected.

When the process proceeds to S40, it is determined whether or not the contact position, which is a position where the fingertip contacts with the operation surface, is detected by the touchpad 21, based on the contact position information from the touchpad 21. When the contact position is not detected by the touchpad 21 (S40: NO), the operation input process is ended.

When the contact position is detected by the touchpad 21 (S40: YES), the process proceeds to S50 in which the pointer PT (see FIG. 4) is displayed on the display screen 11 so that the pointer points to a display position on the display screen 10 that is pre-set to correspond to the contact position indicated by the contact position information from the touchpad 21.

At S60, it is determined whether or not the movable part 22 is pressed down in the X-axis direction, based on the press operation detection information from the press operation detection sensor 24. When the movable part 22 is not pressed down (S60: NO), the operation input process is ended. When the movable part 22 is pressed down (S60: YES), the process proceeds to S60 in which it is determined whether or not an icon in the presently-selected operation image is pointed to by the pointer PT.

When an icon is not pointed to by the pointer PT (S70: NO), the operation input process is ended. When an icon is pointed to by the pointer PT (S70: YES), the process proceeds to S80 in which the icon pointed to by the pointer is selected, and the operation input process is ended.

In the remote control system 1 configured above, the touchpad 21 includes the operation surface and detects the contact position which is a position in the operation surface at which the driver contacts. The input device includes the movable part 22 movable in the two dimensional directions and connected to the touchpad 21 and detects the two dimension coordinate point indicating the displacement of the movable part 22.

The remote control controller 4 selects one of the operation images G1 and the operation images G2 by using the detection result of the input device 3 (S30). Further, the remote control controller 4 specifies the position pointed to by the pointer in the selected operation image, by using the detection result of the touch pad 21(S50).

In this remote control system 1, the touch position in the operation surface, that is, the two dimensional coordinate point in the operation surface, is detected by the touchpad 21. Further, in the remote control system 1, the two dimensional coordinate point indicating the displacement of the movable part 22 is detected by the input device 3. Therefore, a user who operates the remote control system 1 can input a first two dimensional coordinate point by contacting the operation surface of the touchpad 21, and can input a second two dimensional coordinate point by displacing the movable part 22.

Because the position in the operation surface 11 of the display device 2 can be inputted by two dimensional coordinates, the operation image G1, G2 displayed on the display screen and the position in the operation image G1, G2 can be pointed to by the first two dimensional coordinate point and the second two dimensional coordinate point.

According to the remote control system 1, the selection of an operation image in the display screen 11 and the specifying of the position in the selected operation image, respectively, can be made by the input made by the contact with the operation surface of the touchpad 11 and the input made by the displacement of the movable part 22. Accordingly, it becomes unnecessary to make, by contacting with the operation surface of the touchpad 11, both the selection of an operation image and the specifying of the position in the operation image. This suppresses an occurrence of wrong operations.

The movable part 22 includes the mount portion 31, and the holding portion 33. The mount portion 31 is mounted with the touchpad 21, so that the driver can contact with the operation surface of the touchpad 21. The holding portion 33 is arranged next to the operation surface of the touch pad 21 and is arranged on the same surface of the mount portion 31 as the touchpad 21 is arranged on.

Accordingly, by holding the holding portion 33, the driver can operate the movable part 22. Additionally, because the operation surface of the touchpad 21 is positioned next to where the holding portion 33 is held with the hand, the driver can, while holding the holding portion 33, operate the touchpad 21 by touching the operation surface of the touchpad 21 using the fingertip of the hand which is also operating the movable part 22.

In the above embodiment, the remote control system 1 corresponds to a display control system. The touchpad 21 corresponds to a touch detector. The input device 3 corresponds to a displacement detector. The movable part 22 corresponds to a connection member. The process at S30 corresponds to a region selector (means). The operation images G1, G2 correspond to display regions. The process at S50 corresponds to a position specifier (means).

Although one embodiment has been illustrated above, embodiments are not limited to that illustrated above and various embodiments are possible.

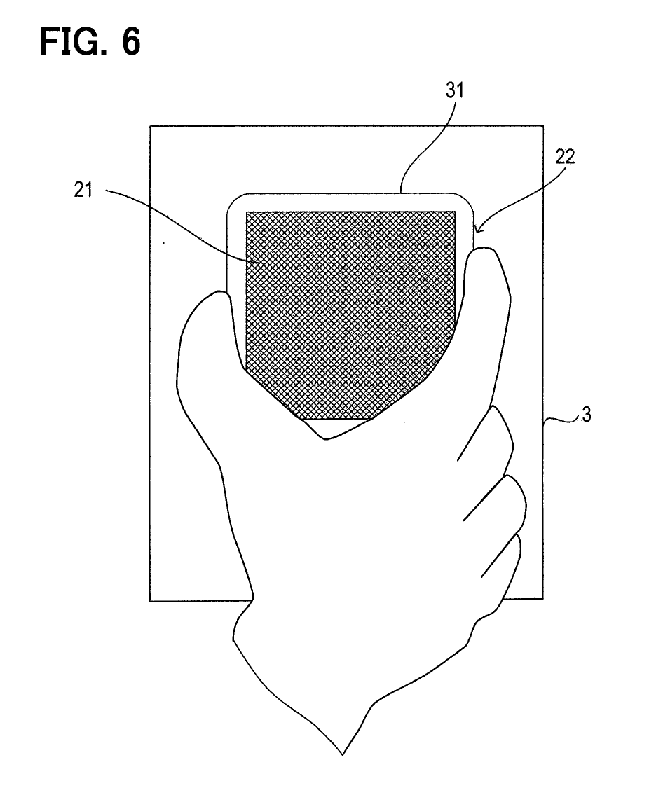

For example, in the above embodiment, the movable part 22 includes a holding portion 33. Alternatively, as shown in FIG. 6, the holding portion 33 may be omitted and the mount portion 31 may be held.

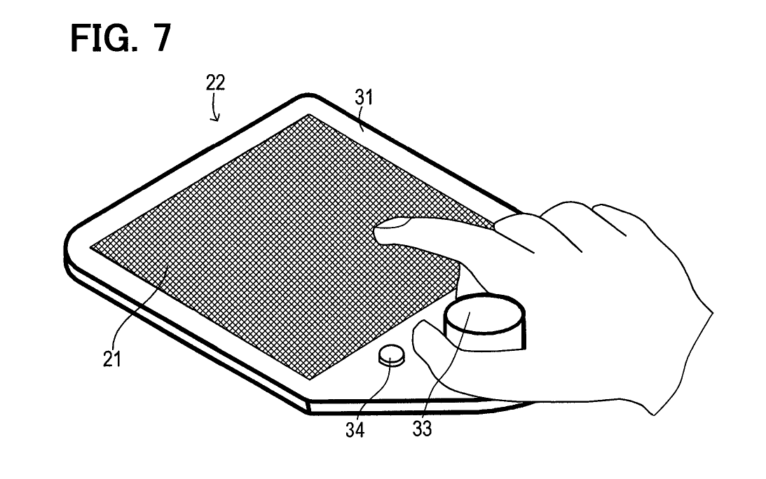

In the above embodiment, the movable part 22 is pressed down to select the icon pointed to by the pointer PT. Alternatively, as shown in FIG. 7, a selection button 34 for selecting an icon pointed to by the pointer PT may be equipped to the movable part 22.

In the above embodiment, the movable part 22 is displaced to select the operation image and the touchpad 21 is operated to move the pointer PT. Alternatively, the movable part 22 may be moved to move the pointer PT and the touchpad 21 may be operated to select the operation image.

In the above embodiment, two operation images are displayed on the display screen 11 and the operation image is selected based on the movement direction of the movable part 22 relative to the neutral position. Alternatively, three or more operation images may be displayed on the display screen 11. In this case, the two dimensional coordinate point indicating the displacement of the axis portion 32 may be specified based on the operation position information from the position detection sensor 23, and this two dimensional coordinate point may be associated with the two dimensional coordinate point in the display screen 11. Then, when the driver presses down the axis portion 32 at a time when the desired operation image desired by the driver is pointed to, the operation image may be selected.

1. A display operating system (1) comprising:
a contact detector (21) that has an operation surface and detects a contact position where a user contacts the operation surface;
a displacement detector (3) that includes a connection member (22) connected to the contact detector and movable in two dimensional directions and detects a two dimensional coordinate point indicating displacement of the connection member;
a region selector (S30) that, using one of a contact detection result of the contact detector and a displacement detection result of the displacement detector, selects one of a plurality of display regions configured on a display screen of a display device, wherein the display device displays an image; and
a position specifier (S50) that, using the other of the contact detection result and the displacement detection result not used by the region selector, specifies a position in the display region selected by the region selector.

2. The display operating system according to claim 1, wherein
the connection member includes:
a mount portion (31) on which the contact detector is mounted so that the user can contact the operation surface; and
a holding portion (33) which is to be held by the user and which is positioned next to the operation surface and which is arranged on a same side of the mount portion as the operation surface is arranged.

What is claimed is:

1. A display operating system comprising:
a contact detector that has an operation surface and detects a contact position where a user contacts the operation surface;
a displacement detector that includes a connection member connected to the contact detector and movable in two dimensional directions and detects a two dimensional coordinate point indicating displacement of the connection member;
a region selector that, using one of a contact detection result of the contact detector and a displacement detection result of the displacement detector, selects one of a plurality of display regions configured on a display screen of a display device, wherein the display device displays an image; and
a position specifier that, using the other of the contact detection result and the displacement detection result not used by the region selector, specifies a position in the display region selected by the region selector.

2. The display operating system according to claim 1, wherein
the connection member includes:
a mount portion on which the contact detector is mounted so that the user can contact the operation surface; and
a holding portion which is to be held by the user and which is positioned next to the operation surface and which is arranged on a same side of the mount portion as the operation surface is arranged.
